(19) United States
(12) Patent Application Publication
(10) Pub. No.: US 2019/0285746 A1
(43) Pub. Date: Sep. 19, 2019

(54) SYSTEM AND METHOD FOR DRIVING ULTRASOUND IMAGING TRANSDUCERS

(71) Applicant: COVIDIEN LP, MANSFIELD, MA (US)

(72) Inventor: WEI TAN, SHANGHAI (CN)

(21) Appl. No.: 16/339,495

(22) PCT Filed: Oct. 9, 2016
(86) PCT No.: PCT/CN2016/101557

§ 371 Date: Apr. 4, 2019

(51) Int. Cl. G01S 15/89; G01S 7/52; G10K 11/34; B06B 1/02

(52) U.S. Cl. CPC G01S 15/8915; B06B 1/0215; G10K 11/341; G01S 7/5202

(57) ABSTRACT

An ultrasound imaging system includes a plurality of transducer elements forming a transducer array, each of the plurality of transducer elements configured to transmit a waveform. The ultrasound system further includes a plurality of driving circuits configured to drive the transducer array, each of the plurality of driving circuits including a complex programmable logic device (CPLD) and a plurality of delay elements enabling communication between the plurality of driving circuits and the transducer array, the plurality of delay elements configured to linearly distribute delays to the plurality of transducer elements based on clock period. The clock period acts as a basis for controlling a steering angle of the waveform transmitted by each of the plurality of transducer elements.

### BACKGROUND

### 1. Technical Field

The present disclosure relates generally to ultrasound imaging devices and systems, more particularly, to a system and method for driving ultrasound imaging transducers by complex programmable logic devices (CPLD).

### 2. Discussion of Related Art

An ultrasound imaging system has become a popular diagnostic tool since it has a wide range of applications. Specifically, due to its non-invasive and non-destructive nature, the ultrasound system has been extensively used in the medical profession. Modern high-performance ultrasound systems and techniques are commonly used to produce two or three-dimensional images of internal features of an object (e.g., human organs).

Ultrasound imaging systems generally use a probe containing a wide bandwidth transducer array to transmit and receive ultrasound signals. The ultrasound system forms images of human internal tissues by electrically exciting an acoustic transducer element or an array of acoustic transducer elements to generate ultrasound signals that travel into the body, in a form of plane wave, which is a wave having constant frequency and amplitude. The wavefronts (surfaces of constant phase) of the plane wave are perpendicular to the travelling direction of the plane wave. The ultrasound signals produce ultrasound echo signals that are reflected from body tissues. Various ultrasound echo signals return to the transducer element and are converted into electrical signals, which are amplified and processed to produce ultrasound data for an image of the tissues.

Ultrasound systems employ an ultrasound probe containing a transducer array for transmission and reception of ultrasound signals. The ultrasound signals are transmitted axially with a transmitting beamformer to form desired acoustic beam shape and positions aligned with the direction of a scan head of the ultrasound probe. The ultrasound system forms ultrasound images with a receiving beamformer based on the received ultrasound signals. Recently, the technique of transmitting plane wave ultrasound signals with steering angles has been used to obtain fast frame rate ultrasound image sequences. In this case, however, the steering angles are usually approximated and decimated due to the limited time resolution in digital circuits. A field programable gate arrays (FPGA)-based transmit beamformer may employ quantization to approximate steering angles with numbers of system clock cycles. This approximation may cause uneven distribution of delays on transducer elements and flawed plane wave profiles.

Moreover, recent technologies migrate the receiving beamforming circuitry into software that runs on a general purpose computing device, like a workstation, a personal computer, a tablet, or even a cell phone. This greatly simplifies the circuitry of the system and removes the hardware receiving beamformer. The software is usually implemented with a FPGA or application specific integrated circuit (ASIC), which cuts a significant cost to the ultrasound machines. With the receiving beamformer removed from hardware, the transmitting beamformer is now a dominant cost in the hardware.

Further, the quality and resolution of a resulting image is largely a function of the size and number of transducer elements in such transducer arrays. Medical ultrasound machines typically incorporate a large number of transducer elements. However, since each transducer element typically is coupled to control circuitry, such as FPGA-based circuitry, an increase in the number of transducer elements results in an associated increase in the complexity and cost of the control circuitry.

Accordingly, there is a need for systems and methods of reducing the complexity and cost of transmitting beamforming circuitry.

### SUMMARY

In one aspect, the present disclosure is directed to an ultrasound system including a plurality of transducer elements forming a transducer array, each of the plurality of transducer elements configured to transmit a waveform. The ultrasound system further includes a driving circuitry configured to drive the transducer array. The driving circuitry further includes a transmitting beamformer implemented as hardware including a complex programmable logic device (CPLD) with a plurality of delay elements to generate controllable delays on each transmitting channel, and a plurality of high voltage multiplexers to switch the outputs of the transmitting beamformer to a certain aperture in the transducer array. The plurality of delay elements configured to linearly distribute delays to the plurality of transducer elements to form plane waves based on clock period. The clock period acts as a basis for controlling a steering angle of the waveform transmitted by each of the plurality of transducer elements.

In the disclosed embodiments, the clock period represents a single clock period.

In the disclosed embodiments, the clock period represents multiple clock periods.

In the disclosed embodiments, the clock period is applied directly to the plurality of delay elements.

In the disclosed embodiments, each of the plurality of delay elements includes flip-flop circuits. The flip-flop circuits are D flip-flops assembled in a cascaded configuration.

In the disclosed embodiments, the waveform transmitted by each of the plurality of transducer elements is a plane wave.

In the disclosed embodiments, the plurality of delay elements control delay intervals between adjacent transducer elements of the plurality of transducer elements forming the transducer array.

In the disclosed embodiments, the plurality of driving circuits are less than the plurality of transducer elements of the transducer array.

In the disclosed embodiments, the number of the plurality of driving circuits is greater than or equal to 2.

In one aspect, the present disclosure is directed to an ultrasonic imaging method for scanning with plane wave transmissions. The method includes transmitting planar ultrasonic waves into a target region at an angle relative to a plurality of transducer elements forming a transducer array, driving the transducer array by a plurality of driving circuits included in a complex programmable logic device (CPLD), enabling communication between the plurality of driving circuits and the transducer array by a plurality of delay elements, linearly distributing delays to the plurality of transducer elements based on clock period, and controlling the angle of the planar ultrasonic waves transmitted by each of the plurality of transducer elements based on the clock period.

Further, to the extent consistent, any of the aspects described herein may be used in conjunction with any or all of the other aspects described herein.

The Summary is provided to introduce a selection of concepts in a simplified form that are further described below in the Detailed Description. This Summary is not intended to identify key or essential features of the claimed subject matter, nor is it intended to be used in determining the scope of the claimed subject matter.

### BRIEF DESCRIPTION OF THE DRAWINGS

Various aspects of the present disclosure are described hereinbelow with reference to the drawings, which are incorporated in and constitute a part of this specification, wherein:

FIG. 1A illustrates a conventional ultrasound imaging system and

FIG. 1B illustrates another conventional ultrasound imaging system where the beamforming technology has been migrated into software;

FIG. 2 illustrates an ultrasound imaging system including a complex programmable logic device (CPLD) in accordance with aspects of the present disclosure;

FIG. 3 illustrates CPLD driving circuitry used for driving the transducer elements of the transducer array to generate plane waves, where a single clock period is used as the basis for identifying a steering angle, in accordance with aspects of the present disclosure;

FIG. 4 illustrates CPLD driving circuitry used for driving the transducer elements of the transducer array to generate plane waves, where a multiple of the clock period is used as the basis for identifying a steering angle, in accordance with aspects of the present disclosure; and

FIG. 5 illustrates driving circuits for driving a plurality of transducer elements, in accordance with aspects of the present disclosure.

### DETAILED DESCRIPTION

A detailed description is provided with reference to the accompanying drawings. One of ordinary skill in the art will realize that the following description is illustrative only and is not in any way limiting. Other embodiments of the present disclosure will readily suggest themselves to such skilled persons having the benefit of this disclosure.

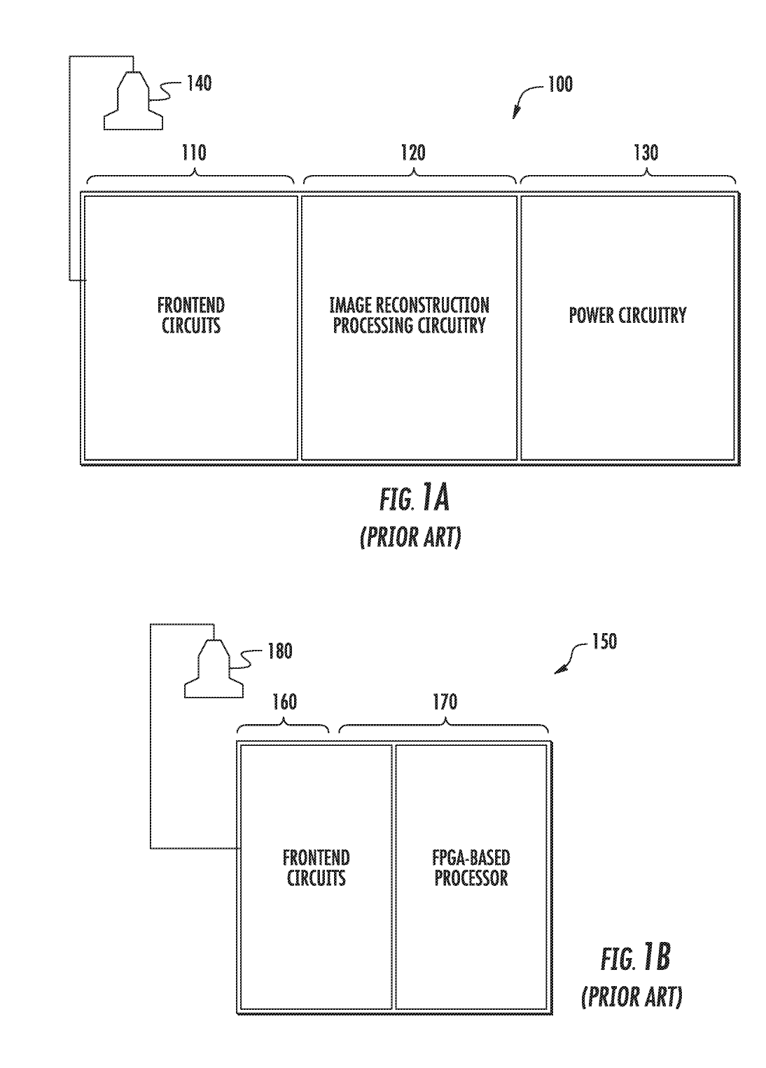

FIG. 1A illustrates a conventional ultrasound imaging system. Ultrasound imaging is a non-invasive subsurface imaging modality widely used in diagnosis, screening, and as an intra-operative surgical guide. As shown in FIG. 1A, a conventional ultrasound machine 100 includes frontend circuits 110 of transmitting driving signals and receiving reflected signals, beamforming and image reconstruction processing circuitry 120, a power circuitry 130, and an ultrasound probe 140. The ultrasound machine is connected to an ultrasound probe via a cable which is used to transmit and receive the ultrasound signals, for example to image a human body.

FIG. 1B illustrates another conventional ultrasound imaging system where the beamforming technology has been migrated into software. The conventional ultrasound machine 150 includes frontend circuits 160, FPGA-based processor 170 for performing the beamforming processing, and an ultrasound probe 180. However, the FPGA-based processing software 170 adds a significant cost to the ultrasound machine 150.

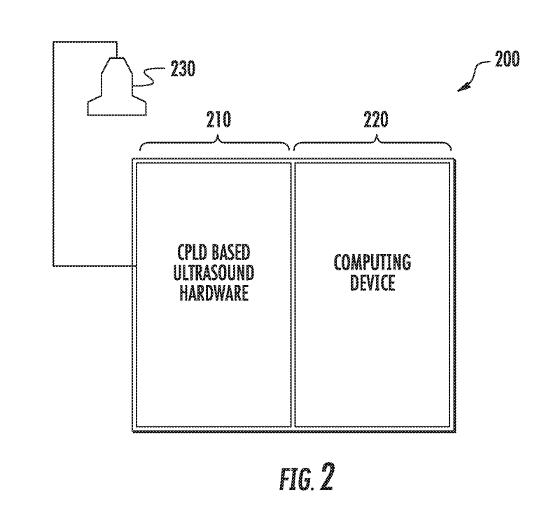

FIG. 2 illustrates an ultrasound imaging system 200, which includes a complex programmable logic device (CPLD) to control beamforming processing, in accordance with aspects of the present disclosure. The ultrasound imaging system 200 includes ultrasound hardware 210 for transmitting driving signals, a computing device 220 for beamforming and image reconstruction processing, and an ultrasound probe 230. The ultrasound hardware 210 may be coupled with the ultrasound probe 230 via a cable or wirelessly (not shown). As addressed in further detail below, various embodiments of transducer elements of the ultrasound probe 230 communicatively coupled to the ultrasound hardware 220 are provided.

The ultrasound hardware 210 controls transmitting driving signals to the ultrasound probe 230. In one embodiment, the ultrasound hardware 210 is electronic, reusable, capable of precise waveform timing and intricate waveform shaping for a plurality of independent transducer elements, and capable of communicating analog or digitized data to the computer to be further processed into ultrasound images. The disclosed embodiments include an ultrasound hardware 210 that houses one or more waveform generators on a CPLD. The foregoing features, among others, have the effect of reducing the size, complexity, and power consumption of the ultrasound system 200 used in conjunction with an ultrasound array. The CPLD is sized and configured to work in a small space at relatively low power.

In particular embodiments, the CPLD may implement an array of ultrasound transmit circuitry with the number of transmitting channels having a 1:1 correspondence with the number of transducer elements. The array of transmit circuitry connects each transducer element to a single transmitting channel. As the number of the transducer elements increases, so does the complexity of the associated CPLD. While the ultrasound hardware 210 may be implemented to include a dedicated waveform generator for each transducer element in the ultrasound probe 230, such an arrangement involves a significant amount of circuitry for each transducer element, and possibly complex routing of signals from the dedicated waveform. Further, such an arrangement may be power intensive and space-constrained.

In accordance with one embodiment of the present disclosure a delta delay techniques is employed in conjunction with the CPLD to address the above-mentioned issues. For example, in a CPLD as provided, delta delay circuit blocks delay transmissions of a digitally-encoded waveform or driving signal, before making this waveform available to the transducer elements of the ultrasound probe 230. In certain embodiments, each delta delay block may add a selectable delay before passing the waveform on to the transducer elements. Delta delay blocks may be provided one or more per each channel present on the CPLD. In this manner, the CPLD may generate signals that determine the firing sequence of the transducer elements. Utilizing the firing sequence, the ultrasound hardware 210 may steer the ultrasonic plane waves to generate the desired wave front shapes. The techniques disclosed herein incorporate delta delay blocks that propagate the waveform signals to the transducers with a small number of channels of waveform generators or driving circuitry than the number of transducer elements. Reducing the number of channels of waveform generators or driving circuitry allows the CPLD to be less power intensive and allows the required circuitry to take up less space. In an aspect, the ultrasound hardware 210 may include a plurality of CPLDs to control transmission of driving signals for multiple channels.

In one particular embodiment, the number of channels in the transmitting circuitry may be eight. The outputs of these eight channels are multiplexed to a transducer array, for example, of 64 or 128 transducer elements. A matrix of D flip-flops is used to form the 8-channel transmitting beamformer, with accurate delay control to all 8 channels with a timing resolution of one clock cycle. Because the delays of pulses sent to transducer elements are linear when forming acoustic plane waves, the output from 8 channels can be multiplexed to drive 64 or 128 elements without compromising either resolution of aperture size. For example in the 1-clock-cycle delay case, channel 1 circuitry will be multiplexed to drive transducer element 9 after channel 8 has sent a pulse to transducer element 8. There is a time interval of 8 clocks between firing a pulse on element 1 and firing a pulse on element 9. The duration is long enough for a low cost high voltage multiplexer. Therefore this technique achieves the same performance as the larger scale plane wave beamformer described above while maintaining a much smaller scale of circuitry. The transmitting beamformer in this case can be implemented with as little as 36 flip-flops for a 1-clock-cycle delta delay or 72 flip-flops for a 2-clock-cycle delay, which is still small enough to be fit in a low cost and small footprint CPLD.

As will be appreciated, as used herein the term “circuitry” may describe hardware, firmware, or some combination of these which are configured or designed to provide the described functionality, such as transmit beamforming. The term “delay” is intended broadly to encompass both temporarily delaying and advancing one signal relative to another.

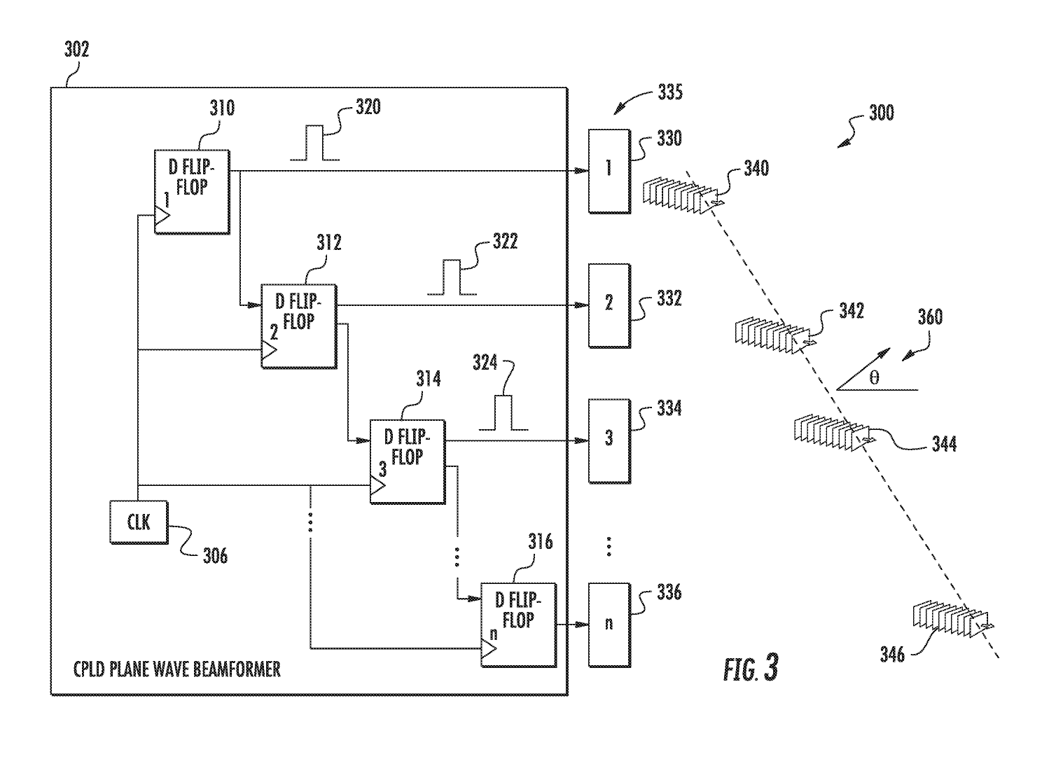

FIG. 3 illustrates CPLD driving circuitry for steering plane waves by driving the transducer elements of the transducer array, where a single clock period is used as the basis for identifying a steering angle, in accordance with aspects of the present disclosure. The ultrasound imaging system 300 depicts CPLD circuitry 302 as a transmit beamformer.

The transmit beamformer 302 transmits a pulse signal and the plurality of delay elements 310, 312, 314, 316 delay the transmitted pulse signal. Additionally, each of the plurality of delay elements 310, for example D flip-flops, 312, 314, 316 is configured to receive a clock signal or clock period from a clock 306. The delays 310, 312, 314, 316 may be arranged in a cascaded configuration. Each D flip-flop 310, 312, 314, 316 is configured to transmit a respective pulse 320, 322, 324 to a respective transducer element 330, 332, 334, 336 of a transducer array 335.

Each of the transducer elements 330, 332, 334, 336 receives and converts the delayed electrical pulse signal into acoustic energy and vice versa. A digital representation of the delayed electrical pulse signal to be transmitted from each transducer element 330, 332, 334, 336. The electrical pulse is defined by a number of parameters including its frequency, the number of cycles, and its delay. The digital representation may be converted into an analog waveform by transducer elements 330, 332, 334, 336.

Each transducer element 330, 332, 334, 336 then transmits respective plane waves (e.g., analog waveform or ultrasonic audio wave) 340, 342, 344, 346 to, for example, a target tissue or structure. Thus, by adjusting the time delays via the plurality of delay elements 310, 312, 314, 316 associated with the pulsed waveforms that energize the respective transducer elements 330, 332, 334, 336, the ultrasonic plane waves 340, 342, 344, 346 can be directed toward or away from an axis associated with surface of the transducer array 335 by a specified angle θ 360 and focused at a fixed range within the patient tissue.

FIG. 3 further illustrates the case when there is a non-zero steering angle. The steering angle θ 360 is given as:

θ=atan(clock_period*c/pitch),

where “c” is a sound velocity, “pitch” is the distance of adjacent transducer elements, and “clock period” is the time period of the clock signal applied to the D flip-flops 310, 312, 314, 316. When the ultrasound imaging system needs to fire a plane wave with steering angle θ, it quantifies the angle into a number of clock periods for each channel, and uses D flip-flops 310, 312, 314, 316 to control the delay intervals between adjacent transducer elements. The cascaded D flip-flops 310, 312, 314, 316 are simple circuits that accurately form a plane wave with the steering angle θ. These temporal offsets result in different activation times of the respective transducer elements 330, 332, 334, 336 such that the wavefront of plane waves emitted by the transducer array 335 is effectively steered or directed in a particular direction with respect to the surface of the transducer array 335.

The present disclosure uses system clock periods as the basis for identifying a steering angle to be used. Thus, possible steering angles are based on a multiple of the clock period used. The steering angle θ 360 may be configured based on the number of delays between consecutive or adjacent transducer elements. In FIG. 3, there is one clock period of delay between the consecutive or adjacent transducer elements 330, 332, 334, 336 of the transducer array 335. Therefore, the plurality of delay elements 310, 312, 314, 316 delay the pulses to each transducer element 330, 332, 334, 336 to steer the plane waves 340, 342, 344, 346 in one or more desired directions.

In one embodiment, the present disclosure uses system clock periods as the basis for identifying a steering angle to be used. Thus, the steering angles possible are based on the clock period used. The steering angle may be configured based on the number of delays between consecutive or adjacent transducer elements.

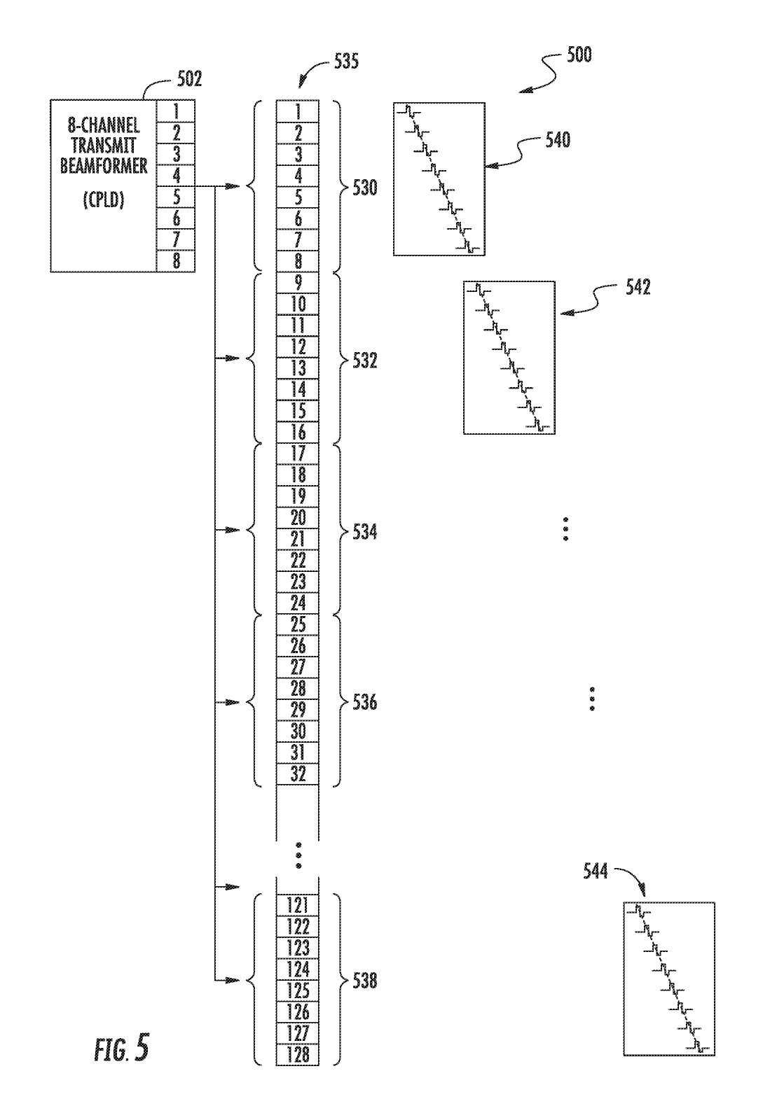

The transmit beamforming circuitry may include a programmable logic device (e.g., CPLD 302). The CPLD 302 digitally controls the delays and characteristic of transmit waveforms, and generates transmit waveforms from memory, which are functions of the transmit waveform. The CPLD 302 may also implement relative delays between the waveforms as well as filter, interpolate, and apply apodization. Other components then perform receiving functions like digital to analog conversion and amplification. In these embodiments, the transducer array 335 may include a multi-element linear, curved linear, phased linear, sector or wide view array. The CPLD 302 of the transmit beamformer processes the plurality of signals associated with such multi-element electrically scanned arrays. For example, the transducer array 335 may provide for 16, 32, 64 or 128 channels, as will be described below with reference to FIG. 5 below.

In operation, an ultrasound scan is performed by using an ultrasound probe to acquire a series of echoes generated in response to transmission of acoustic energy into the tissue of a patient. During such a scan, the transducer array 335 having the plurality of transducer elements 330, 332, 334, 336 is energized to transmit acoustic energy. The acoustic energy generates echo signals after reflecting off of structures or structure interfaces or target tissue. The echo signals are received and converted into electrical signals by each transducer element 330, 332, 334, 336. The converted electrical signals may be further converted into digital signals, which are then provided to receive circuitry (which is not shown).

In one embodiment, in an imaging system featuring software receiving beamforming, the receive circuitry may simply convert the analog echo signals to a digital signal and relay the digital signals to a computing device such as a personal computer, a tablet computer, a cell phone, or any other devices with a processor. The computing device processes the received digital signals with a software based receiving beamformer to continuously generate ultrasound image frames in real time.

The echo signals produced by each burst of acoustic energy are reflected by structures or structure interfaces or target tissue located at successive ranges along the ultrasonic plane waves. The echo signals are sensed separately by each transducer element 330, 332, 334, 336 and a sample of the echo signal magnitude at a particular point in time represents the amount of reflection occurring at a specific range. However, due to the differences in the propagation paths between a reflecting structure and each transducer element 330, 332, 334, 336, these echo signals may not be detected simultaneously.

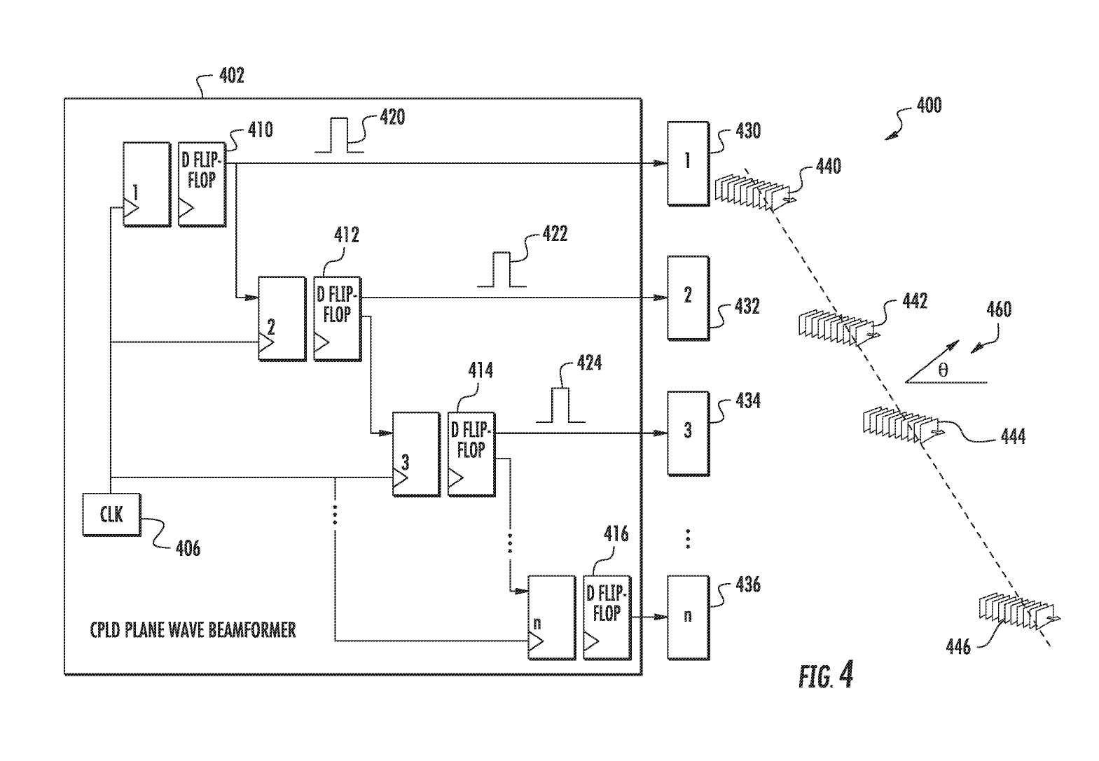

FIG. 4 illustrates CPLD driving circuitry used for driving the transducer elements of the transducer array to generate plane waves, where a multiple of the clock period is used as the basis for identifying a steering angle, in accordance with aspects of the present disclosure. The ultrasound imaging system 400 depicts CPLD circuitry 402 and a wave generator or transmitter 404. The transmitter 704 transmits a pulse signal to the plurality of delay elements 410, 412, 414, 416. Additionally, each of the plurality of delay elements 410, 412, 414, 416 is configured to receive a clock signal or clock period 706. Each D flip-flop 410, 412, 414, 416 is formed by 2 adjacent delays (e.g., D flip-flops), as opposed to the configuration shown in FIG. 3.

Each D flip-flop 410, 412, 414, 416 is configured to transmit a respective delayed pulse 420, 422, 424 to a respective transducer element 430, 432, 434, 436 of a transducer array 435. Each transducer element 430, 432, 434, 436 then transmits respective plane waves 440, 442, 444, 446 to, for example, a target tissue or structure. Thus, by adjusting the time delays via the plurality of delay elements 410, 412, 414, 416 associated with the pulsed waveforms that energize the respective transducer elements 430, 432, 434, 436, the ultrasonic plane waves 440, 442, 444, 446 can be directed toward or away from an axis associated with surface of the transducer array 435 by a specified angle θ 460 and focused at a fixed range within the patient tissue. As noted, each of the plurality of delay elements 410, 412, 414, 416 includes two successive or adjacent D flip-flops to form a larger steering angle, than the steering angle achieved with the configuration shown in FIG. 3.

Therefore, in FIG. 4, there are two clock periods of delay between the consecutive or adjacent transducer elements 430, 432, 434, 436, of the transducer array 435. As a result, the plurality of delay elements 410, 412, 414, 416 delay the pulses 420, 422, 424 to each transducer element 430, 432, 434, 436 to steer the plane waves 440, 442, 444, 446 in one or more desired directions with a larger steering angle than the configuration shown in FIG. 3. Therefore, in accordance with FIGS. 3 and 4, linear distribution of delays among transducer elements is achieved. Consequently, an ultrasound system with configurable delays to transducer elements is achieved, where the delays to the consecutive or adjacent transducer elements are linearly distributed based on a single clock period or multiple clock periods.

FIG. 5 illustrates driving circuits for driving a plurality of transducer elements, in accordance with aspects of the present disclosure. Typically, the number of pulses required to fire multiple transducer elements/channels of a transducer array would equal the number of channels (driving circuits). For example, for a transducer array including 128 transducer elements, 128 parallel sets of drive circuitry would be required to drive the 128 transducer elements. In contrast, the ultrasound imaging system of the present disclosure enables the number of drive circuitry channels to be reduced to less than the number of transducer elements.

The embodiments of the present disclosure accomplish this by the following methodology: after the 1^{st} through 8^{th} channels fire their sequential pulses, switching is performed to enable the same drive circuitry to then drive the 9^{th} through 16^{th} channels, and so on. The linear delay profile of a plane wave allows such multiplexing without compromising the plane wave waveform. Theoretically, one can use 1 driving circuitry channel to drive all 128 channels, or at least 2 driving circuitry channels may be required because of the switching time required for the switch circuitry. The embodiments of the present disclosure use 8 drive circuitry channels to drive 128 transducer elements of a transducer array, based on speed/capability of commercially available components.

FIG. 5 illustrates an exemplary driving system 500 where a plurality of driving circuits in transmit beamformer 502 (totaling 8 driving circuits) drives the transducer array 535 (including 128 channels or elements). The transducer array 535 may be split into 16 sub-apertures, each sub-aperture including 8 transducer elements/channels 530, 532, 534, 536, 538. Thus, firstly driving circuits in the transmit beamformer 502 is configured to drive the first 8-channel sub-aperture 530 (channels 1-8), and after the driving circuit 8 in the transmit beamformer 502 finished sending the pulse for channel 8, the 8-channel driving circuits are multiplexed to the second sub-aperture 532 (channels 9-16). Because the pulse delay profile of a plane wave is linear, and the time interval between firing a pulse on the first sub-aperture and firing another pulse on the next sub-aperture is over 8 pulse widths, the same CPLD 502 has sufficient time to control high voltage switches and multiplex along the sub-apertures 530 to 538. As a result, splitting the 128 transducer elements into 16 sections, and driving those 16 sections via 8 driving circuitry channels may be implemented with commercially available components. Of course, one skilled in the art may contemplate any number of driving circuits for driving any number of channels of a transducer array.

There are many transducer array systems contemplated by the disclosed embodiments. Most of the description focuses on a description of a diagnostic medical ultrasound system; however, the disclosed embodiments are not so limited. The description focuses on diagnostic medical ultrasound systems solely for the purposes of clarity and brevity. It should be appreciated that disclosed embodiments apply to numerous other types of methods and systems.

In a transducer array system, the transducer array is used to convert a signal from one format to another format. For example, with ultrasound imaging the transducer converts an ultrasonic wave into an electrical signal, while a radar system converts an electromagnetic wave into an electrical signal. While the disclosed embodiments are described with reference to an ultrasound system, it should be appreciated that the embodiments contemplate application to many other systems. Such systems include, without limitation, radar systems, optical systems, audible sound reception systems.

However, these detailed embodiments are merely examples of the disclosure, which may be embodied in various forms. Therefore, specific structural and functional details disclosed herein are not to be interpreted as limiting, but merely as a basis for the claims and as a representative basis for allowing one skilled in the art to variously employ the present disclosure in appropriately detailed structure.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

1. An ultrasound system, comprising:
a plurality of transducer elements forming a transducer array, each of the plurality of transducer elements configured to transmit a waveform; and
a driving circuit configured to drive the transducer array, the driving circuit including:
a configurable transmitting beamformer configured to generate pulse signals and drive the transducer array; and
a plurality of delay elements enabling communication between the driving circuit and the transducer array, each of the plurality of delay elements configured to linearly delay the pulse signal to a corresponding one of the plurality of transducer elements based on a period,
wherein the period controls a steering angle of the waveform transmitted by each of the plurality of transducer elements.

2. The ultrasound system according to claim 1, wherein the driving circuit is implemented with a complex programmable logic device.

3. The ultrasound system according to claim 1, wherein the driving circuit further includes a plurality of high voltage multiplexers to multiplex outputs of the driving circuit to a transducer aperture with a number of transducers more than a number of channels in the driving circuit.

4. The ultrasound system according to claim 1, wherein the driving circuit includes a plurality of transmitting beamformers and a number of the plurality of delay elements is equal to a number of the plurality of transmitting beamformers.

5. The ultrasound system according to claim 1, wherein the driving circuit includes a plurality of transmitting beamformers and a number of the plurality of delay elements is a multiple of a number of the plurality of transmitting beamformers.

6. The ultrasound system according to claim 1, wherein the driving circuit includes a plurality of transmitting beamformers and a number of the plurality of transducer elements is a multiple of a number of the plurality of transmitting beamformers.

7. The ultrasound system according to claim 1, wherein the period represents a single clock period.

8. The ultrasound system according to claim 1, wherein the period represents multiple clock periods.

9. The ultrasound system according to claim 1, wherein each of the plurality of delay elements includes at least one flip-flop.

10. The ultrasound system according to claim 9, wherein the at least one flip-flop of each of the plurality of delay elements is cascaded.

11. The ultrasound system according to claim 1, wherein the plurality of delay elements control delay intervals between adjacent transducer elements of the plurality of transducer elements forming the transducer array.

12. A method for ultrasonic scanning with a plane wave transmission, the method comprising:
generating a pulse signal by a plurality of transmitting beamformers;
linearly delaying the generated pulse signal to a corresponding one of a plurality of transducer elements forming a transducer array based on a period by a plurality of delay elements of the plurality of transmitting beamformers;
driving the transducer elements with a plurality of driving circuits based on the delayed pulse signal;
transmitting planar ultrasonic waves into a target region at an angle relative to the plurality of transducer elements forming a transducer array; and
controlling the angle of the planar ultrasonic waves transmitted by each of the plurality of transducer elements based on the period.

13. The method according to claim 12, wherein the angle of the planar ultrasonic waves is controlled based on a number of delay elements in each transmitting beamformer.

14. The method according to claim 12, wherein the period is a single clock period.

15. The method according to claim 12, wherein the period is multiple clock periods.

16. The method according to claim 12, wherein the plurality of delay elements is cascaded.

17. The method according to claim 12, further comprising controlling delay intervals between adjacent transducer elements of the plurality of transducer elements forming the transducer array by the plurality of delay elements.

18. The method according to claim 12, wherein a number of the plurality of transducer elements of the transducer array is a multiple of a number of the plurality of transmitting beamformers.

19. The method according to claim 12, further comprising driving a subset of the plurality of transducer elements of the transducer array via one driving circuit of the plurality of driving circuits.

20. A driving circuit for driving a transducer array of an ultrasound device, the driving circuit comprising:
a plurality of transmitting beamformers configured to generate pulse signals; and
a plurality of delay elements enabling communication between the driving circuit and the transducer array, each of the plurality of delay elements configured to linearly delay the pulse signal to a corresponding transducer element of the transducer array based on a period,
wherein the period is configured to control a steering angle of a waveform transmitted by each transducer element of the transducer array.
